(19) United States
(12) Patent Application Publication
(10) Pub. No.: US 2009/0207131 A1
(43) Pub. Date: Aug. 20, 2009

(54) ACOUSTIC POINTING DEVICE, POINTING METHOD OF SOUND SOURCE POSITION, AND COMPUTER SYSTEM

(75) Inventors: Masahito TOGAMI, Higashiyamato (JP); Takashi Sumiyoshi, Kokubunji (JP); Yasunari Obuchi, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/269,155

(22) Filed: Nov. 12, 2008

(30) Foreign Application Priority Data
Feb. 19, 2008 (JP) 2008-037534

(51) Int. Cl. G06F 3/033

(52) U.S. Cl. 345/156

(57) ABSTRACT

There is disclosed an acoustic pointing device that is capable of performing pointing manipulation without putting any auxiliary equipment on a desk. The acoustic pointing includes a microphone array that retains plural microphone elements; an A/D converter that converts analog sound pressure data into digital sound pressure data; a buffering that stores the digital sound pressure data; a direction of arrival estimation unit that executes estimation of a sound source direction of a transient sound based on a correlation of the sound between the microphone elements obtained by the digital sound pressure data; a noise estimation unit that estimates a noise level in the digital sound pressure data; an SNR estimation unit that estimates a rate of a signal component based on the noise level and the digital sound pressure data; a power calculation unit that computes and outputs an output signal from the rate of a signal component; an integration unit that integrates the sound source direction and the output signal to specify a sound source position; and a control unit that converts, based on data in a DB of screen conversion, the specified sound source position into one point on a screen of a display device.

### CLAIM OF PRIORITY

The present application claims priority from Japanese patent application JP2008-037534 filed on Feb. 19, 2008, the content of which is hereby incorporated by reference into this application.

### BACKGROUND OF THE INVENTION

The present invention relates to a pointing device for a user to designate a spot or point on a screen of a display device of a computer, more specifically to a pointing device technique using acoustic information.

In general, a pointing device using a mouse is often used to manipulate objects on a computer screen. The mouse operation and the movement of a cursor of a pointing device on the computer screen interwork, so a user can select a desired point on the screen by moving the cursor onto the point and clicking the mouse button on the point.

In addition, pointing devices using a touch panel are already part of products for people's everyday life and widely used worldwide. In a touch panel, each point on the display is mounted with a detector to sense pressing pressure by a user against the screen, and the detectors decide which points are pressed.

Some pointing devices use acoustic information. For example, there is a device using a special pen to produce ultrasound when pressed against the screen (e.g., see JPA Laid-Open Publication No. 2002-351605).

Some devices generate ultrasonic waves as well as light, and detect a pointed position based on the time difference of ultrasonic wave and light arriving at the sound receiving element and the light receiving element, respectively (e.g., see JPA Laid-Open Publication No. 2002-132436).

Some devices detect a pointed position based on the direction of vibration which is detected by vibration detectors provided on the display as vibration is generated when a fingertip of a user touches the screen of the display (e.g., see JPA Laid-Open Publication No. 2002-351614).

### BRIEF SUMMARY OF THE INVENTION

The pointing device using a mouse to manipulate objects on a computer screen is not always convenient because there has to be a desk or something similar to put the mouse on. Meanwhile, the touch panel does not require such auxiliary equipment. However, the touch panel requires a special display, each element on the display has to be attached with a pressing pressure detector, and a touch should be done very close to the display.

According to the techniques disclosed in JPA Laid-Open Publication No. 2002-351605 and JPA Laid-Open Publication No. 2002-132436, a user needs to use a special pen or a coordinate input device. Also, according to the technique disclosed in JAP Laid-Open Publication No. 2002-351614, vibrations are generated when a user touches the screen and the generated vibrations are detected to find out a pointed position.

In view of foregoing problems, an object of the present invention is to provide an acoustic pointing device that enables pointing manipulation by the user based on acoustic information even from a remote place, without necessarily using auxiliary equipment on a desk for the manipulation of objects on a computer screen, a pointing method of a sound source position, and a computer system using the acoustic pointing device.

In accordance with an aspect of the present invention, there is provided an acoustic pointing device for detecting a sound source position of a sound to be detected and converting the sound source position into one point on a screen of a display device, including a microphone array that retains plural microphone elements; an A/D converter that converts analog sound pressure data obtained by the microphone array into digital sound pressure data; a direction of arrival estimation unit that executes estimation of a sound source direction of the sound to be detected based on a correlation of the sound between the microphone elements obtained by the digital sound pressure data; an output signal calculation unit that estimates a noise level in the digital sound pressure data and computes a signal component of the sound based on the noise level and the digital sound pressure data to output the signal component as an output signal; an integration unit that integrates the sound source direction with the output signal to specify the sound source position; and a control unit that converts the specified, sound source position into one point on the screen of the display device.

In the acoustic pointing device according to the present invention, the microphone array is constituted of plural sub microphone arrays, wherein the device further includes a triangulation unit that integrates, by triangulation, the sound source directions estimated from each of the sub microphone arrays by the direction of arrival estimation unit to obtain the sound source direction and compute a distance to the sound source position, and a direction decision unit that decides whether the sound source direction and the distance are within a predetermined area, wherein the integration unit integrates the output signal with the sound source direction and the distance within the area to specify the sound source position, and wherein the control unit converts the specified, sound source position into one point on the screen of the display device.

Moreover, in the acoustic pointing device according to another aspect of the present invention, the microphone array is constituted of plural sub microphone arrays, wherein the device further includes a converter that converts the digital sound pressure data into a signal in a time-frequency area, a triangulation unit that integrates, by triangulation, the sound source directions that are estimated from each of the sub microphone arrays by the direction of arrival estimation unit using the signal to obtain the sound source direction and compute a distance to the sound source position, and a direction decision unit that decides whether the sound source direction and the distance are within a predetermined area, wherein the integration unit integrates the output signal with the sound source direction and the distance within the area to specify the sound source position, and the control unit converts the specified sound source position into one point on the screen of the display device.

Furthermore, in the acoustic pointing device according to another aspect of the present invention, the microphone array is constituted of plural sub microphone arrays, the device further includes a converter that converts the digital sound pressure data into a signal in a time-frequency area, a triangulation unit that integrates, by triangulation, the sound source directions that are estimated from each of the sub microphone arrays by the direction of arrival estimation unit using the signal to obtain the sound source direction and compute a distance to the sound source position, a direction decision unit that decides whether the sound source direction and the distance are within a predetermined area, an output signal decision unit that decides whether the output signal from the output signal calculation unit is equal to or greater than a predetermined threshold, a database of sound source frequencies that prestores frequency characteristics of the sound to be detected, and a database of screen conversion that stores a conversion table capable of specifying the one point on the screen from the sound source position, wherein the integration unit performs weighting by the frequency characteristics upon the output signal which is equal to or greater than the threshold and integrates the sound source direction and the distance within the area to specify the sound source position, and wherein the control unit converts the specified sound source position into one point on the screen using information in the database of screen conversion.

Still another aspect of the present invention provides a pointing method of a sound source position for use with the acoustic pointing device, and a computer system mounted with the acoustic pointing device.

In the manipulation of objects on a computer screen, an acoustic pointing device in accordance with the present invention enables pointing manipulation by a user based on acoustic information even from a remote place, without necessarily using auxiliary equipment on a desk.

Also, it is possible to provide a pointing method of a sound source position for use with the acoustic pointing device.

Furthermore, it is possible to provide a computer system mounted with the acoustic pointing device.

### BRIEF DESCRIPTION OF THE DRAWINGS

FIG. 1 is a brief schematic view of an acoustic pointing device in accordance with one embodiment of the present invention;

FIG. 2 is a brief schematic view of the acoustic pointing device using signals in a time area only;

FIG. 3A is a schematic diagram of hardware configuration of the acoustic pointing device;

FIG. 3B is a schematic diagram of hardware configuration of a computer system equipped with the acoustic pointing device;

FIG. 4A is a diagram showing a linear alignment of a sub microphone array used for the acoustic pointing device;

FIG. 4B is a diagram showing a linear alignment of a sub microphone array used for the acoustic pointing device;

FIG. 5 is a diagram showing an example of a setup for beaten position by user in use of the acoustic pointing device on a desk;

FIG. 6 is a diagram showing a beaten position detection flow in the acoustic pointing device;

FIG. 7 is a diagram showing a decision and integration process flow in the acoustic pointing device;

FIG. 8 is a diagram showing a time waveform of a beating sound in the acoustic pointing device;

FIG. 9 is a grid diagram for each time-frequency component in the acoustic pointing device;

FIG. 10 is a diagram showing power in each sound source direction in the acoustic pointing device;

FIG. 11 is a diagram showing an example where a beating area is set in the height direction in the acoustic pointing device;

FIG. 12 is a diagram showing the alignment for a sub microphone array in the acoustic pointing device;

FIG. 13 is a diagram showing an application example where the acoustic pointing device is applied to a beating sound detector;

FIG. 14 is a diagram showing another application example where the acoustic pointing device is applied to a beating sound detector;

FIG. 15 is a diagram showing yet another application example where the acoustic pointing device is applied to a beating sound detector;

FIG. 16 is a diagram showing yet another application example where the acoustic pointing device is applied to a beating sound detector;

FIG. 17 is a diagram showing yet another application example where the acoustic pointing device is applied to a beating sound detector; and

FIG. 18 is a diagram showing yet another application example where the acoustic pointing device is applied to a beating sound detector.

### DETAILED DESCRIPTION OF THE INVENTION

Reference will now be made in detail to the preferred embodiments of the present invention, examples of which are illustrated in the accompanying drawings.

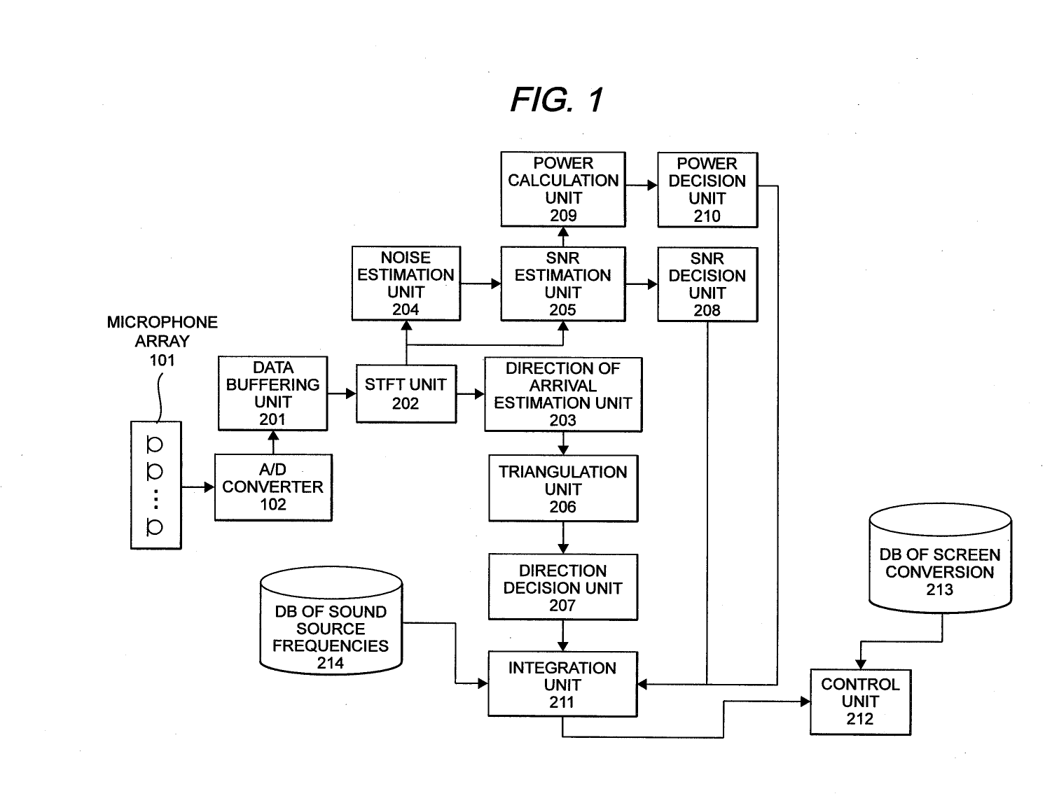

FIG. 1 is a brief schematic view of an acoustic pointing device in accordance with one embodiment of the present invention. The acoustic pointing device is used for replacement of a mouse of a personal computer (hereinafter it will be referred to as “PC”), which helps a user designate a specific position on the display simply by beating the desk. The gentle beating sound on the desk, which corresponds to a sound to be detected as a sound source of the acoustic pointing device, will now be referred to as a “transient sound”. The acoustic pointing device shown in FIG. 1 includes a microphone array 101 which is constituted by at least two or more microphone elements (hereinafter they will also be referred to as “microphones”); an A/D (Analogue to Digital) converter 102 which converts analog sound pressure data on multi-channel transient sounds from the microphones in the microphone array 101 into digital sound pressure data; a data buffering unit 201 which stores a specific amount of the digital sound pressure data; a STFT (Short Term Fourier Transform) unit 202 which converts the digital sound pressure data into time-frequency signals; a direction of arrival estimation unit 203 which divides the microphone array into plural sub microphone arrays (hereinafter they will also be referred to as “sub arrays”) and performs the estimation of a direction of arrival of a transient sound that is computed by correlation of sounds between microphones in the same sub microphone array, based on azimuth and elevation angles; a triangulation unit 206 which integrates sound source directions from each sub microphone array and measures azimuth angle, elevation angle, and distance to a sound source; a direction decision unit 207 which decides whether the sound source position obtained by the triangulation unit 206 falls within a predetermined range; a noise estimation unit 204 which estimates a background noise powder from the digital sound pressure data; an SNR estimation unit 205 which estimates an SNR (Signal to Noise Ratio) from the digital sound pressure data and the noise power; an SNR decision unit 208 which outputs an SNR with an estimation value outputted from the SNR estimation unit 205 being equal to or greater than a predetermined threshold; a power calculation unit 209 which calculates signal power from the digital sound pressure data and the SNR; a power decision unit 210 which outputs signal power equal to or greater than a predetermined threshold; an integration unit 211 which outputs a time-frequency component that is specified concurrently by the SNR decision unit and the power decision unit in coordinates of a sound source position within a predetermined area given by the direction decision unit; and a control unit 212 which converts the coordinates of a sound source position into a specific point on a display screen.

In addition, the acoustic pointing device includes a database (hereinafter it will be referred to as a “DB”) 214 of sound source frequencies, which stores in advance frequency characteristics of target sounds; and a DB 213 of screen conversion which matches the coordinates of a sound source with a specific point on the display screen.

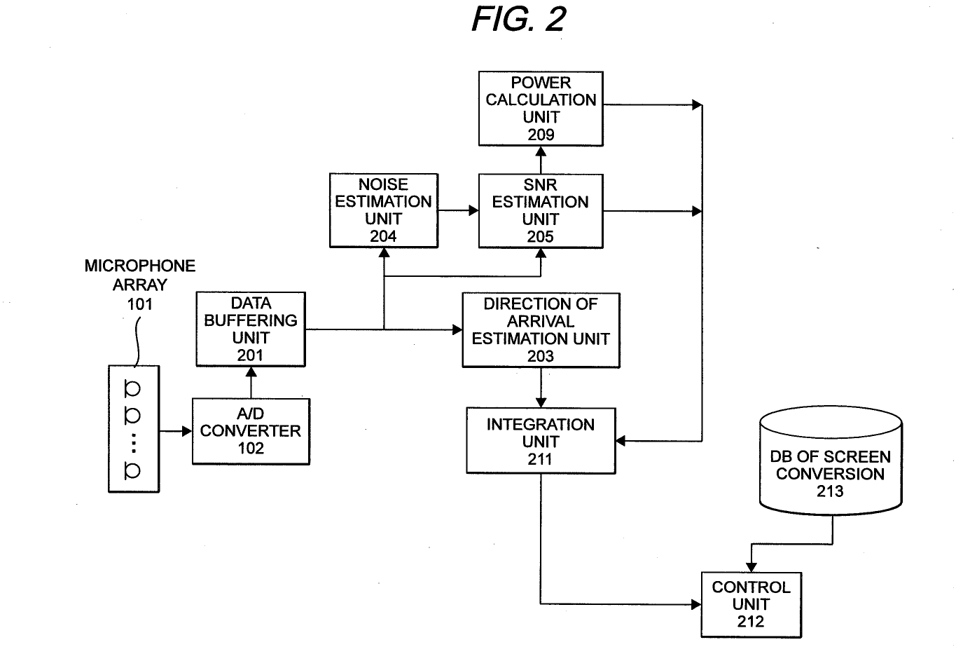

In the case where only time signals are used for the digital sound pressure data, it is possible to specify the position of a sound source without the need of the STFT unit 202, the power decision unit 210, the SNR decision unit 208 and the DB 214 of sound source frequencies. FIG. 2 shows a brief schematic view of the acoustic pointing device that uses signals in a time area only. FIG. 2 defines a minimum configuration for specifying the position of a sound source. Here, an output signal calculation module indicates the noise estimation unit 204, the SNR estimation unit 205, and the power calculation unit 209. To more accurately specify the position of a sound source, the triangulation unit 206 and the direction decision unit 207 are also needed.

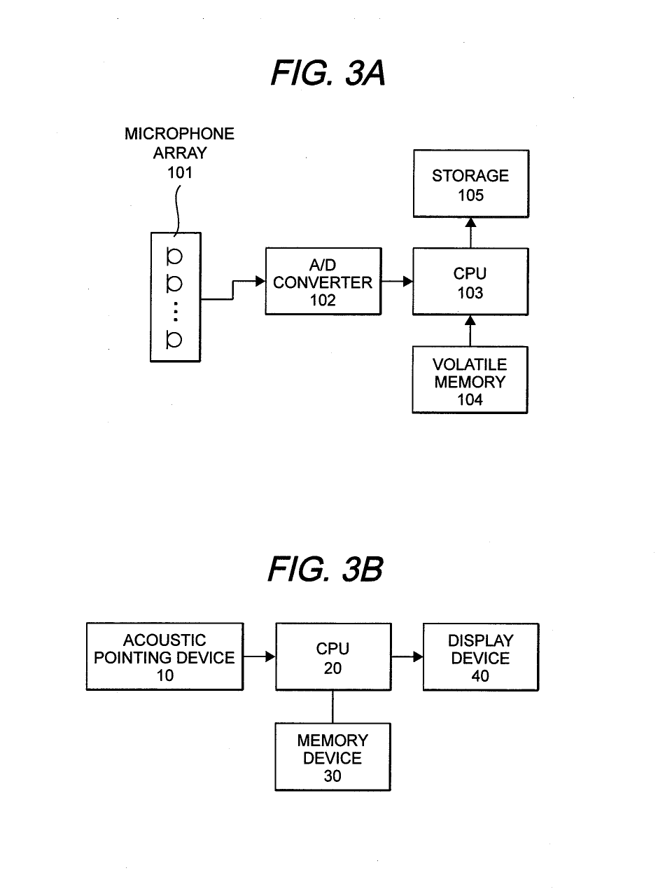

FIGS. 3A and 3B are schematic diagrams, showing hardware configuration of the acoustic pointing device and hardware configuration of a computer system equipped with the acoustic pointing device, respectively. FIG. 3A is a schematic diagram of hardware configuration of the acoustic pointing device which is constituted by a microphone array 101 discussed earlier, an A/D converter 102 for converting the analog sound pressure data into digital sound pressure data, a central processing unit 103 for executing processes associated with the acoustic pointing device, a memory 104, and a storage 105 for storing programs associated with the acoustic pointing device or physical coordinates of each microphone in an microphone array. As the program runs, all constituent elements except the microphone array 101 and the A/D converter 102 of the acoustic pointing device shown in FIG. 1 are implemented using the volatile memory 104 on the central processing unit 103.

FIG. 3B is a schematic diagram of hardware configuration of a computer system equipped with the acoustic pointing device. The computer system includes an acoustic pointing device 10, a central processing unit 20 for processing a program that uses information about a sound source position of the acoustic pointing device 10, a memory device 30 used for the program or an operation process, and a display device 40 for displaying a sound source position as a point on a screen.

The following will now explain in detail about each constituent unit shown in FIG. 1.

Multi-channel digital sound pressure data that have been converted by the A/D converter 102 are accumulated at a specific amount for each channel in the data buffering unit 201. Generally, the process in a time-frequency area is not carried out whenever a sample is obtained, but it is carried out collectively after plural samples are obtained. That is, the process is not executed at all until a specific digital sound pressure is accumulated.

The data buffering unit 201 has a function of accumulating such a specific amount of digital sound pressure data. Digital sound pressure data which is obtained from each microphone is processed distinguishably by an index (i) starting from 0 according to microphone. For ‘n’ as an integral, digital sound pressure data of the i-th microphone that is sampled on the n-th time is denoted as xi(n).

The STFT (Short Term Fourier Transform) unit 202 converts digital sound pressure data from each microphone into time-frequency signals by applying the following (Formula 1).

$${X}_{i} ( f , τ ) = {\sum }_{n = 0}^{N - 1} w ( n ) {x}_{i} ( s τ + n ) {e}^{- j \frac{2 π f}{N} n} \qquad [ Formula 1 ]$$

where j is defined as in Formula 2 as follows.

[Formula 2]

j=\sqrt{−1}

Xi(f, τ) is the f-th frequency component of the i-th microphone. ‘f’ ranges from 0 to N/2. N is a data length of digital sound pressure data that is converted into a time-frequency signal. Typically, it is called a frame size. S is usually called a frame shift which indicates a shift amount of digital sound pressure data during its conversion into a time-frequency signal. The data buffering unit 201 continuously accumulates digital sound pressure data until a new S sample is acquired for each microphone, and once the S sample is acquired the STFT unit 202 converts it into a time-frequency signal.

‘τ’ is a frame index which corresponds to a count or the number of times digital sound pressure data is converted into a time-frequency signal. ‘τ’ starts from 0. ‘w(n)’ is a window function, and typical examples of such a function include Blackmann window, Hanning window, and Hamming window. By the use of a window function, high precision time-frequency resolution can be achieved.

Digital sound pressure data that is converted into a time-frequency signal is transferred to a direction of arrival estimation unit 203.

The direction of arrival estimation unit 203 divides a microphone array constituted by microphones into plural sub microphone arrays, and estimates a sound source direction of each sub microphone array in an individual coordinate system. Suppose that one microphone array is divided into R sub microphone arrays. Then, M microphones that constitute the microphone array are allocated to at least one of R sub microphone arrays. For instance, those M microphones can be allocated to two or more sub microphone arrays, and in this case plural sub microphone arrays have the same microphones.

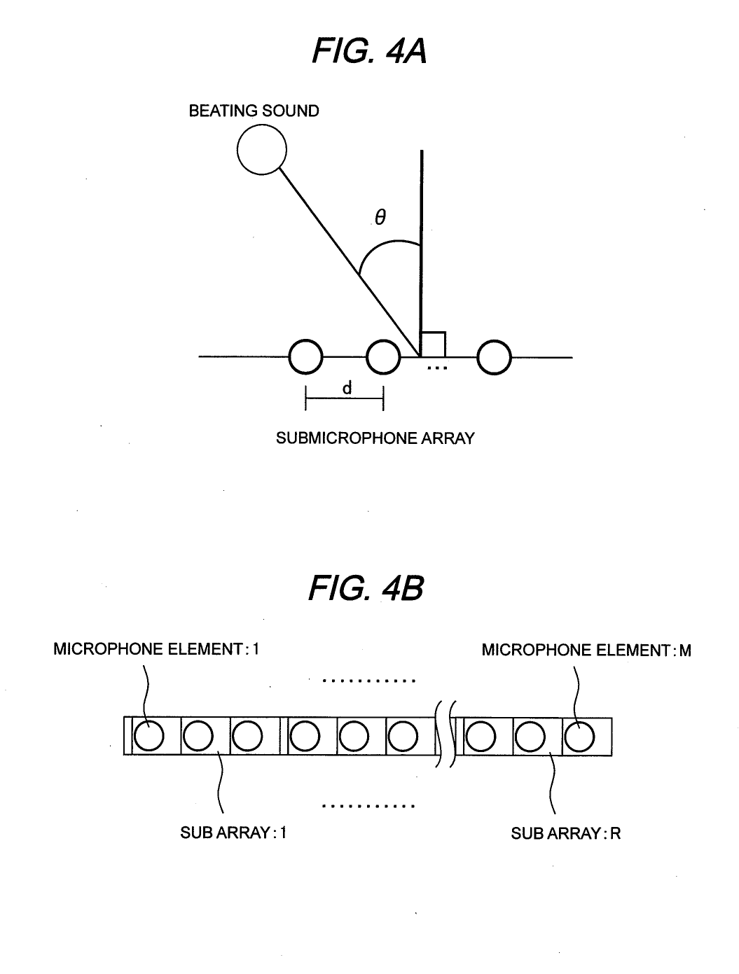

FIGS. 4A and 4B show a sub microphone array. FIG. 4A shows the linear alignment of a sub microphone array. In the case of the linear alignment, a direction that is orthogonal to an array direction along which microphones are aligned in a row is set to 0 degree, and only an angle (θ) between the direction (0 degree) and a straight line that connects a sound source and a sub microphone array in the counterclockwise direction can be estimated. In FIG. 4A, ‘d’ denotes a space between microphones. FIG. 4B shows a state where M microphones as noted before are allocated to R sub microphone arrays, one sub microphone array being allocated with three microphones.

When two microphones of a sub microphone array are aligned in parallel on the surface of a desk, the angle (θ) is estimated as an azimuth angle in the horizontal direction. Meanwhile, when two microphones of a sub microphone array are aligned perpendicularly to the surface of a desk, the angle (θ) is estimated as an elevation angle in the vertical direction. In this manner, azimuth and elevation angles are estimated.

Suppose that a sub microphone array has at least two microphones. Then, angle (θ) can be estimated by applying Formula 3, provided that there are two microphones in each sub microphone array.

$$θ ( f , τ ) = arcsin \frac{ρ ( f , τ )}{2 π {Fdc}^{- 1}} \qquad [ Formula 3 ]$$

Here, ρ is a phase difference in frame (τ) and frequency index (f) of input signals of two microphones. F is a frequency of the frequency index (f), i.e., F=(f+0.5)/N×Fs/2. Fs is a sampling rate of the A/D converter 102. d is a physical space (m) between two microphones. c is the speed of sound (m/s). Technically, sound speed varies with temperature and density of a medium, but 340 m/s is universally recognized as the sound speed.

The internal process of the direction of arrival estimation unit 203 is the same for any time-frequency, so the suffix (f, τ) of the time-frequency will be omitted in the description that follows. As aforementioned, the direction of arrival estimation unit 203 carries out the same process on each time-frequency area. If a sub microphone array has three or more microphones which are aligned on the same line, the direction can be computed very accurately by SPIRE algorithm in the linear alignment. More details on the SPIRE algorithm are described in M. Togami, T. Sumiyoshi, and A. Amano, “Stepwise phase difference restoration method for sound source localization using multiple microphone pairs”, ICASSP 2007, vol. I, pp. 117-120, 2007.

In the SPIRE algorithm, since multiple microphone pairs of different spaces between neighboring microphones (hereinafter they are referred to as “microphone spaces”, it is desirable to align microphones that constitute a sub microphone array at different microphone spaces from each other. A microphone pair of a smaller microphone space is sorted out first, in an increasing order. For p as an index for specifying one microphone pair, a microphone pair with the smallest microphone space is where p=1, while a microphone pair with the largest microphone space is where p=P. The following process is executed sequentially from p=1 to p=P. First, an integral np that satisfies the following condition (Formula 4) is obtained.

$${\hat{ρ}}_{p - 1} \frac{{d}_{p}}{{d}_{{p}_{- 1}}} - π \leq {ρ}_{p} + 2 π {n}_{p} \leq {\hat{p}}_{p - 1} \frac{{d}_{p}}{{d}_{{p}_{- 1}}} + π \qquad [ Formula 4 ]$$

Since the term at the center surrounded by inequality signs falls within a range of 2π, only one solution is found. And, the following (Formula 5) is executed.

[Formula 5]

\hat{ρ}ₚ₋₁=ρₚ+2πnₚ

Before executing the above process for p=1, the following (Formula 6) is given as an initial value.

[Formula 6]

\hat{ρ}₀=0

Also, note that dp is a space between microphones in the p-th microphone pair. The above process is executed until p=P, and then a sound source direction is estimated by the following (Formula 7).

$$θ ( f , τ ) = arcsin \frac{{\hat{ρ}}_{p} ( f , τ )}{2 π {Fd}_{p} {c}^{- 1}} \qquad [ Formula 7 ]$$

Accuracy of the estimation of a sound source direction is known to increase along with a larger microphone space. If the microphone space is longer than a half wavelength of a signal for direction estimation, it is impossible to specify one direction from the phase difference between microphones so there exist two or more directions that have the same phase difference (spatial aliasing). The SPIRE algorithm has a mechanism to select a direction with a smaller microphone space out of two or more estimated directions that are generated with a large microphone space as the direction close to the sound source direction. Therefore, the SPIRE algorithm is advantageous in that a sound source direction can be estimated at high precision even with a large microphone space that causes special aliasing. If microphone pairs are aligned non-linearly, the SPIRE algorithm for non-linear alignment makes it possible to compute an azimuth angle and sometimes even an elevation angle.

Meanwhile, if the digital sound pressure data is not a time-frequency signal, i.e., data of a time area only, the SPIRE algorithm cannot be used. As long as the data in a time area only is concerned, GCC-PHAT (Generalized Cross Correlation PHAse Transform) method is used for direction estimation.

The noise estimation unit 204 estimates a background noise level of an output signal from the STFT unit 202. For estimation of a noise level, MCRA (Minima Controlled Recursive Averaging) may be used. MCRA noise estimation process is based on a minimum statistics method. The minimum statistics method sets a minimum power among many frames as an estimate for the noise power per frequency. In general, voice or beating sound on a desk often has a transient power per frequency, yet hardly maintains that large power for a long period of time. Therefore, a component that takes a minimum power among many frames can be approximated with a component containing only noise, and a noise power even in a voice utterance section can be estimated at high precision. An estimated microphone and a noise power per frequency are denoted as M(f, τ). Index for a microphone is denoted as ‘i’, and a noise power is estimated for every microphone. Because the noise power is updated per frame, it varies by τ. The noise estimation unit 204 outputs an estimated microphone and a noise power Ni(f, τ) per frequency.

If data in a time area only is concerned, noise, compared with a transient sound, has a low output power but tends to stay for a longer period of time, thereby making it possible to estimate a noise power.

The SNR estimation unit 205 estimates an SNR (Signal To Noise Ratio) by the following (Formula 8) using an estimated noise power and an input signal Xi(f, τ) of a microphone array being given.

$$S N {R}_{i} ( f , τ ) = 10 {log}_{10} \frac{{\vert {X}_{i} ( f , τ ) \vert}^{2}}{{N}_{i} ( f , τ )} - 1 \qquad [ Formula 8 ]$$

SNRi(f, τ) is an SNR of frame (τ) and frequency index (f) of the microphone index (i). The SNR estimation unit 205 outputs an estimated SNR. The SNR estimation unit 205 may smooth an input power in the time direction. In so doing, stable SNR estimation which is strong against noise can be achieved.

The triangulation unit 206 integrates sound source directions, each being obtained from a sub microphone array, so as to measure azimuth angle, elevation angle, and distance to a sound source. A sound source direction obtained from the i-th sub microphone array with respect to a sound source direction obtained from a coordinate system for each sub microphone array is denoted as follows:

[Formula 9]

θᵢ(f,τ)

For instance, as shown in FIG. 4A, a direction that is orthogonal to an array direction is defined as 0 degree, and a counterclockwise direction from the direction that is orthogonal to an array direction is defined as a sound source direction. In general, a sound source direction is composed of two components: azimuth angle and elevation angle. If only one of them can be estimated (e.g., sub microphone arrays are aligned linearly), the sound source direction can be composed of only one element. In this case, the sound source direction that is obtained from the coordinate system of the i-th sub microphone array with one component is converted into a sound source direction in an absolute coordinate system. Suppose Pi denotes a source sound direction in the converted absolute coordinate system. By the i-th sub microphone array result, a sound source is estimated to exist on the sound source direction Pi. As such, it is reasonable to consider a cross-over of the sound source direction Pi obtained from all the sub microphone arrays as the position of a sound source. Accordingly, the triangulation unit 206 outputs the cross-over of the sound source direction Pi as the position of a sound source.

Normally, there is more than one cross-over in the sound source direction Pi. If this is the case, a cross-over for two sound source directions is obtained by combination of all sub microphone arrays, and an average of those crossings is outputted as the position of a sound source. By averaging, robustness for non-uniformity of crossing positions is improved.

In some cases, two sound source directions may not have a crossing at all. In this case, a solution that is obtained by combination of sub microphone arrays with no crossing may not be used for estimation of the position of a sound source in a time-frequency area, or estimation of the position of a sound source in a relevant time-frequency area may not be executed at all. Having no cross-over implies that there is another sound source besides the observation target sound source, so noise is included in the phase difference information. Because a sound source position having been estimated in such a time-frequency area is not used, the position of a sound source can be estimated at higher precision.

Moreover, if a sub microphone array is aligned linearly, it is not always possible to estimate both azimuth and elevation angles, so only the angle between the array direction of the sub microphone array and the sound source can be estimated. In this case, a sound source exists on the plane which is the estimate of an angle between the array direction of the sub microphone array and the sound source. A cross-over on such a plane, which is obtained from each sub microphone array, is then outputted as a sound source position or a sound source direction. However, if all the sub microphone arrays are aligned linearly, an average of crossovers on the plane obtained by combination of all sub microphone arrays is outputted as the position of a sound source. By averaging, robustness for non-uniformity of cross-over positions is somewhat improved.

Meanwhile, if some sub microphone arrays are aligned linearly and other sub microphone arrays are aligned non-linearly, one of linearly aligned sub microphone arrays and one of non-linearly aligned sub microphone arrays are combined to get an estimate of the sound source position. In the case of combining the linear alignment and the non-linear alignment, a minimum number of sub microphone arrays with one cross-over being determined is designated as one unit, and an average of crossovers obtained by combination of all sub microphone arrays is outputted as a final estimate of the position of a sound source.

The direction decision unit 207 decides whether a sound source position obtained by the triangulation unit 206 is on a desk or within a predetermined beating area. If two aspects or conditions, concerning whether an absolute value of height of a sound source from the desk, the sound source having been calculated from information on the sound source position obtained by the triangulation unit 206, is not larger than a predetermined threshold and whether planar coordinates of a sound source that has been calculated from information on the sound source are within a beating area, are satisfied, the direction decision unit 207 outputs a sound source direction and a distance to the sound source as the information on the sound source position. Also, it may output a sound source direction and a distance to the sound source as an azimuth angle and an elevation angle. Given that the above-described two conditions are met at the same time, the direction decision unit 207 outputs a plus decision result, while it outputs a negative decision result if the conditions are not met at the same time. The integration unit 211 (to be described) integrates the plus decision result with the sound source direction and distance outputted from the triangulation unit 206. The definition of a beating area will be explained later on.

The SNR decision unit 208 outputs a time-frequency component for which an SNR estimate per time-frequency outputted from the SNR estimation unit 205 is equal to or greater than a predetermined threshold. With a given SNR per time-frequency outputted from the SNR estimation unit 205, the power calculation unit 209 calculates a signal power Ps by applying the following (Formula 10).

$$Ps = \frac{S N R}{S N R + 1} Px \qquad [ Formula 10 ]$$

where Px is power of an input signal.

The power decision unit 210 outputs a time-frequency component for which signal power per time-frequency outputted from the power calculation unit 209 is equal to or greater than a predetermined threshold. The integration unit 211 increases power, which is outputted from the power calculation unit 209 of a time-frequency component that has been specified by both the power decision unit 210 and the SNR decision unit 208 at the same time, as a weight per frequency that is kept in the DB 214 of sound source frequencies. That is to say, if frequency characteristics of a target sound (e.g., beating sound on the desk) can be measured in advance, the frequency characteristics are stored in the DB 214 of sound source frequencies. And through the increased by the power stored in the DB 214 of sound source frequencies, it becomes possible to execute the position estimation at higher precision.

The power decision unit 210 and the SNR decision unit 208 both give a zero weight to a non-specific time-frequency component. Also, they give a zero weight to a time-frequency component that turned out to be not within the beating area according to the direction decision unit 207.

In this embodiment, the output signal decision module indicates the SNR decision unit 208 and the power decision unit 210.

Suppose that a beating area is cut into a grid of several centimeters for each side and that the estimation result of a sound source position of a relevant component per time-frequency is included within the i-th grid. A weight power corresponding to the power Pi of the grid is then added. This power addition process of the grid is performed for every time-frequency. A grid with a maximum power after the addition process is then outputted as the final position of a sound source. The size or quantity of grids is predefined.

Duration of the power addition process of the grid can also be predefined, or the above-described addition process may be carried out only for a time zone that is decided as a voice section by VAD (Voice Activity Detection). By making duration of the addition process short, one can reduce reaction time taken until the position of a sound source is decided after a beating sound is given. However, shorter reaction time creates a problem of weakness at noise.

On the other hand, if duration of the addition process is made long, reaction time taken until the position of a sound source is decided after a beating sound is given also increases, yet robustness is enhanced against noise. Thus, duration of the addition process should be set in consideration of such a trade-off relationship. Usually a beating sound lasts about 100 ms, so the addition process should preferably last about the same amount of time. If the maximum power of grid is smaller than a predetermined threshold, it is decided that no beating sound was made so the result is discarded. Meanwhile, if the maximum power of grid is greater than a predetermined threshold, a sound source position thereof is outputted and the process in the integration unit 211 is terminated.

The control unit 212 converts the coordinates of a sound source position of a beating sound having been outputted from the integration unit 211 into a particular point on a screen, based on the information from the DB 213 of screen conversion.

The DB 213 of screen conversion retains a table for converting the input coordinates of a sound source position into a particular position on a screen. Any conversion method (e.g., linear conversion by a 2×2 matrix) is acceptable as long as a sound source position of a beating sound can be converted into a point on a screen. For instance, disregard information obtained from the position estimation of a sound source about the height of the sound source, and control the PC as if a point on a conversion screen that is obtained by matching position information of the sound source on a plane with a point on the screen had been clicked or dragged. Also, height information can be interpreted in different ways. For instance, if the height information says that a sound is being produced from a certain height above a given level, it is regarded that one point on the screen must have been double clicked. Meanwhile, if the height information says that a sound is being produced from a certain height below a given level, it is regarded that one point on the screen must have been clicked. In so doing, user manipulation can become more diverse in manner.

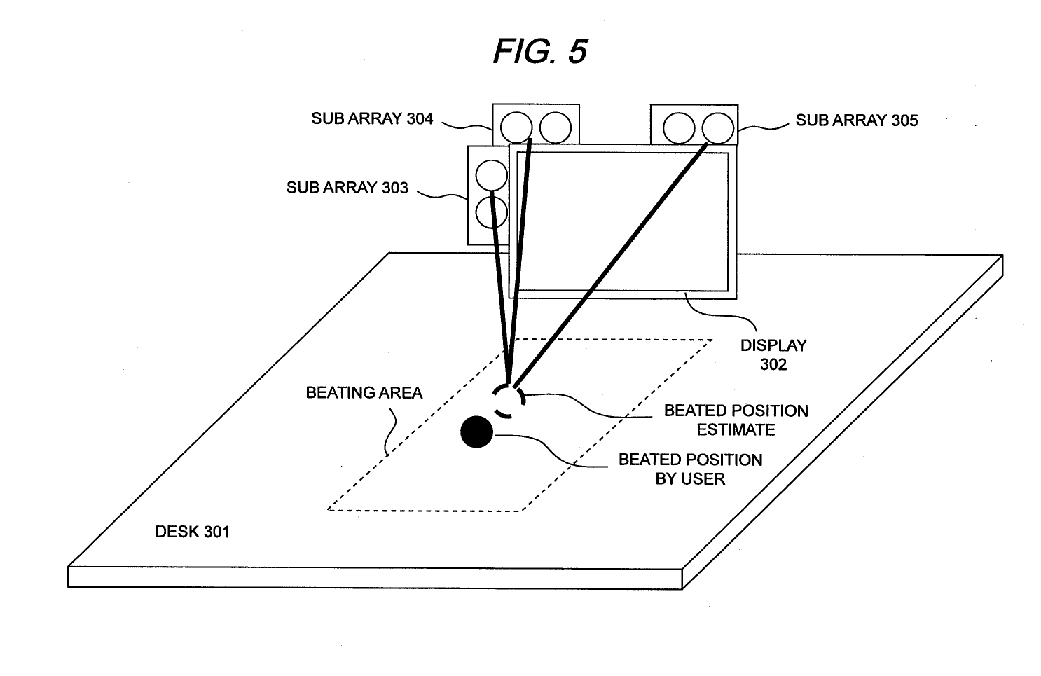

FIG. 5 is a diagram showing an example of a setup for beaten position by user in use of the acoustic pointing device on a desk. A plane with a table is designated in advance as a beating area on a desk 301, a target which is being beaten. If the estimated position of a sound source of a beating sound happens to be within the beating area, the sound is received. Microphone arrays like sub microphone arrays 303 to 305 may be set on a display 302, or may be set on the desk separately. Here, the sub microphone array 303 estimates an elevation angle, and the sub microphone arrays 304 and 305 estimate an azimuth angle. By installing sub microphone arrays on the display, the center of the coordinate axis of the microphone arrays is matched with the center of the display such that one can intuitively specify a point on a virtual space of the display.

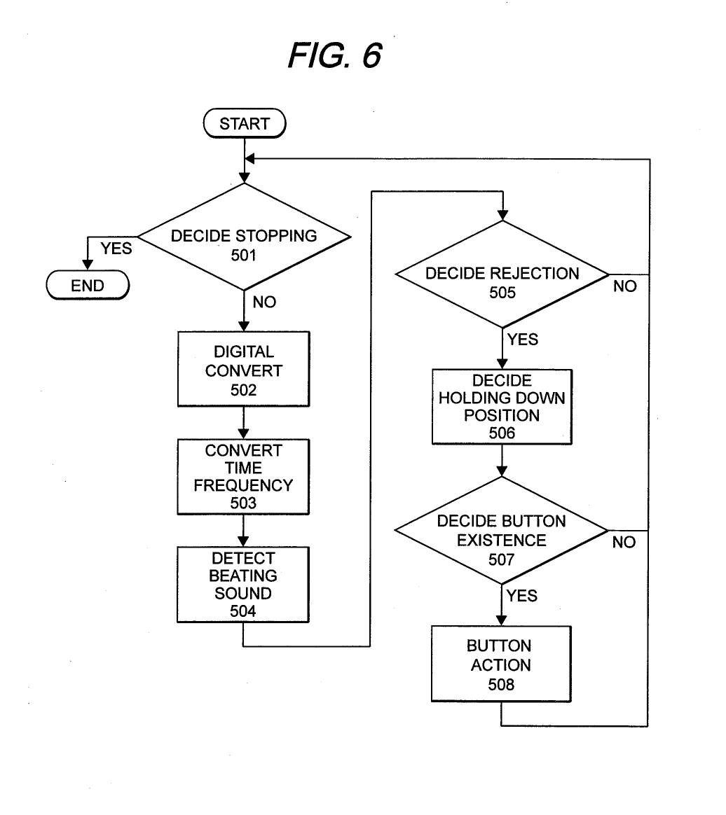

FIG. 6 describes a process flow in a device for discerning a button on a screen held down by a user, based on a detected beaten position on the desk.

After the system starts, in step 501 for a stopping decision, it is decided how a user is going to end the program such as either by shutting down the computer or by pressing the end button of the beaten position detection program on the desk.

If a stopping decision is made in step 501 for a stopping decision, the program is ended and the process is terminated. If a stopping decision is not made, however, the process goes to step 502 for digital conversion where analog sound pressure data called out of a microphone array is converted into digital sound pressure data. The conversion is executed in the A/D converter. The digital sound pressure data after the conversion is then called into the computer. Digital conversion can be done on each sample, or plural samples having a matching minimum process length of a beating sound on the desk can be called into the computer at once. In step 503 for time-frequency conversion, the digital data being called in is decomposed into a time-frequency component by SFFT. With the use of SFFT, it becomes possible to estimate a sound source direction per frequency component.

Under the environment using the desk beating sound program, human voice often exists as noise in addition to the desk beating sound. Human voice is a sparse signal in the time-frequency area, and known to be widespread in part of a particular frequency band. Therefore, by estimating a sound source direction in the time-frequency area, it becomes easier to reject frequency components where human voice is widespread and the beating sound detection can be done with improved precision.

In step 505 for a decision of rejection, it is decided whether the detected beating sound is really a beating sound within the beating area of the desk. If the detected beating sound is not within the beating area of the desk, the stopping decision in step 501 is carried out. However, if the detected beating sound is within the beating area of the desk, mapping between each point in the beating area and a point on the screen is defined in advance, and a decision of holding down position is made in step 506 to discern a button holding down position and thus to specify one point on the screen based on information on the beaten position according to the mapping. In step 507 for a decision of button existence, it is decided whether the button exists in a position of the beating area. If it is decided no such button exists, the process returns to step 501 for the stopping decision. However, if it is decided the button exists in the beating area, a button action in step 508 is executed in the same manner as clicking the button on the screen with a mouse or other pointing device.

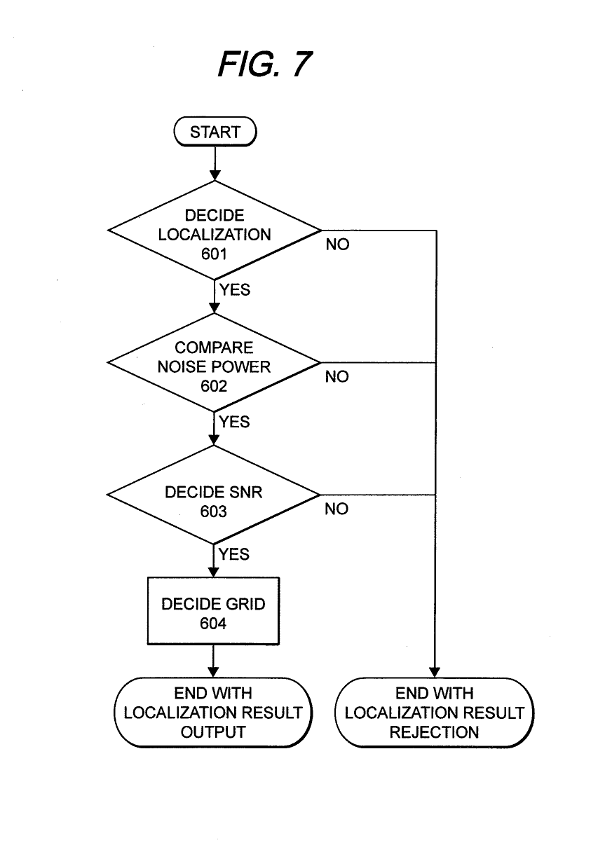

FIG. 7 describes in detail the process flow in the direction decision unit, the power decision unit, the SNR decision unit and the integration unit. In step 601 for a localization decision, the direction decision unit 207 decides whether azimuth and elevation angles are within a predetermined beating area, based on the information about sound source direction and distance, i.e., azimuth and elevation angles, which is obtained by the triangulation unit using plural sub microphone arrays per time-frequency component. Here, the predetermined beating area may take the form of a desk-like rectangular area similar to the beating area that is described in FIG. 5, or may have a spatial thickness. Any space that can help making the decision, from the information on the azimuth and elevation angles, regarding whether the azimuth and elevation angles are within the beating area, is acceptable.

In step 602 for comparison of noise power, the power decision unit 210 decides whether the size of the beating sound is greater, compared with a noise power that is estimated by the MCRA method. The MCRA method is for estimating power of the background noise among mixed sounds of voice and background noise. The MCRA method is based on minimum statistics. The minimum statistics regards a minimum power within several frames as the power of the background noise, assuming that voice has a transient large volume. Meanwhile, one should note that the power of the background noise estimated by the minimum statistics tends to be smaller than the power of the actual background noise. The MCRA method smoothes the background noise power that is estimated by the minimum statistics in the time direction for correction, and computes a value close to the actual background noise power. From an aspect that a beating sound, although not a voice, has a transient large power and has the same statistical nature as the voice, a method for estimation of background noise power such as the MCRA method can be applied.

If the noise power is greater than the power of the beating sound, an SNR of the power of next background noise and the power of a beating sound is calculated. In step 603 for an SNR decision, the SNR decision unit 208 decides whether the beating sound power is greater than the calculated SNR, and if so, it decides a time-frequency component thereof as a beating sound component.

The integration unit 211 divides a beating area into a grip in advance. The time-frequency component that has been decided as the beating sound component is allocated into a grid corresponding to the estimates of azimuth and elevation angles of the component. At the time of allocation, a frequency-dependent weight is added to the power of the beating sound component corresponding to the grid. This process is carried out on a predetermined frequency band and for a predetermined duration. In step 604 for grid detection, a grid with a maximum power is detected, and the azimuth and elevation angles of the grid are outputted as the azimuth and elevation angles of a beating sound, thereby specifying a sound source. Here, if the power of the grid with a maximum power is below a predetermined threshold, it is decided that a beating sound does not exist.

The process sequence for the direction decision unit 207, the power decision unit 210, and the SNR decision unit 208 is not limited to the order shown in FIG. 7. However, each process for the direction decision unit 207, the power decision unit 210, and the SNR decision unit 208 should be terminated prior to the process in the integration unit 211.

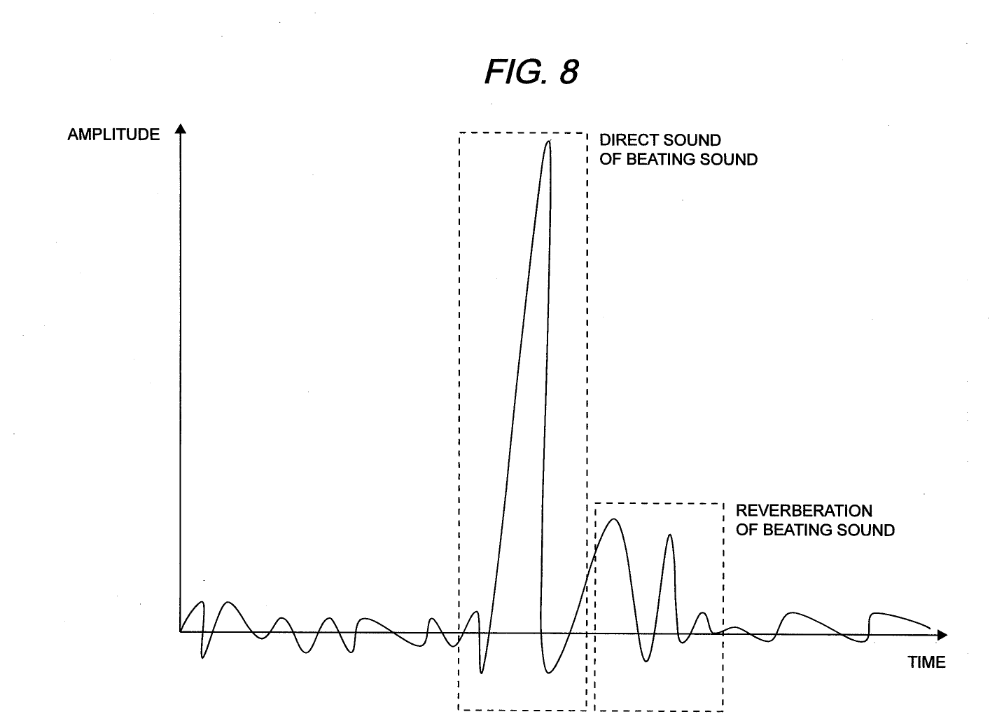

FIG. 8 shows a typical time waveform of a beating sound. A beating sound has a transient large value (direct sound of the beating sound). Reverberation of the beating sound comes after that. This reverberation can be regarded as a sound coming from diverse directions. Therefore, since it is not easy to do the direction estimation merely by comparing the reverberation with the direct sound, the reverberation is not appropriate for the direction estimation of a beating sound. Considering that the reverberation usually has a lower power than the direct sound, any component of lower power than a transient large sound may not be regarded as a beating sound. From such a viewpoint, when the frequency decision unit allocates a bating sound component per time-frequency to each grid, it may not allocate any component of lower power than a previous frame to the grid. Through this process, it becomes possible to detect a beating sound that is strong at the reverberation.

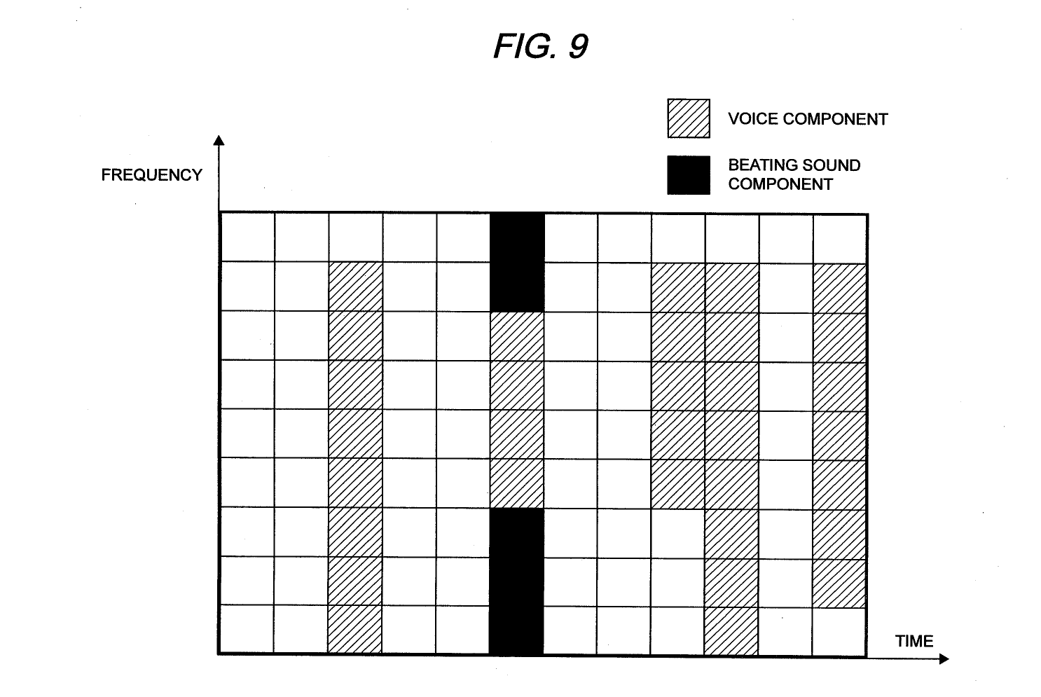

FIG. 9 is a diagram showing the allocation of a time-frequency component to a grid. It is assumed that a beating sound detector is used for replacement of the PC manipulation equipment like a mouse. Therefore, it is also assumed that plural voice sources like people talking exist in an environment where the beating sound detector is used. This reminds that the beating sound detector which operates robustly is needed even in the environment where voice sound sources exist. As noted earlier, voice is a sparse signal in the time-frequency area. That is, it is widespread in part of a particular frequency band. Therefore, by eliminating part of the widespread components, one may operate the beating sound detector robustly even in the environment where voice sound sources exist.

The integration unit 211 decides whether the azimuth and elevation angles are within a beating area and regards a sound as a beating sound only if the angles are within the beating area. By making such a decision, it becomes possible to reject part of the time-frequency area where the voice components are widespread.

The integration unit 211 operates to output a grid with the maximum power. To do so, it obtains a direction along which the power in each of the sub microphone arrays is a maximum, integrates the maximum directions, and estimates a sound source direction of the beating sound by triangulation.

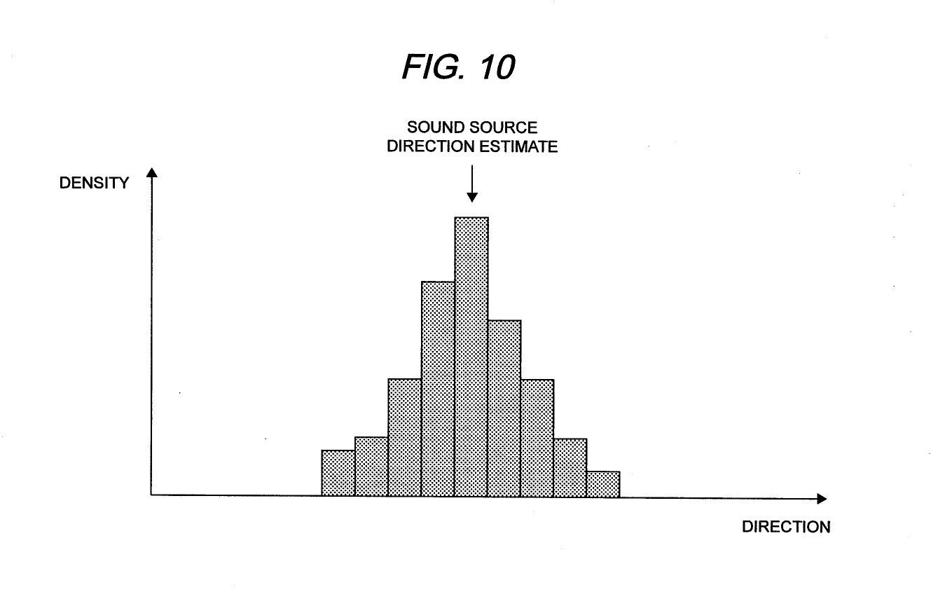

FIG. 10 shows an example of density in each direction of a sub microphone array. For instance, as shown in FIG. 10, powers in all directions seen from each of the sub microphone array are added. In a system for allocating a time-frequency component to the two-dimensional plane or the three-dimensional space, the number of components being allocated to each grid is often extremely low. In this case, a histogram is computed for each sub microphone array, a direction which yields a maximum vale of each histogram is obtained, and those directions are integrated by triangulation to achieve a robust estimation.

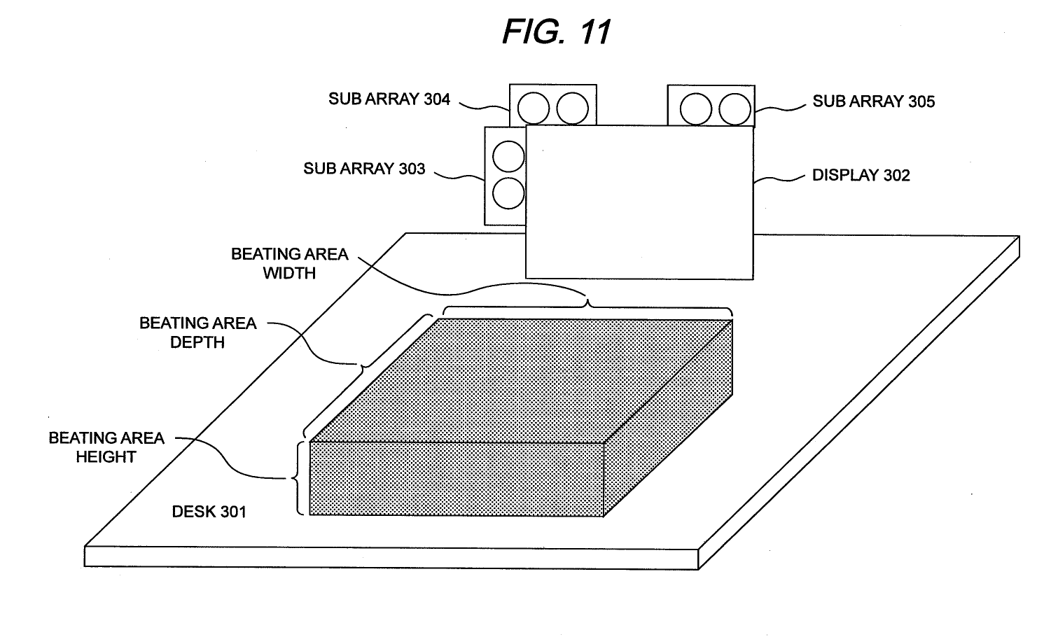

FIG. 11 shows an example where a beating area is set to have a depth in the height direction. By allowing a beating area to have a depth in the height direction as in this example, not only an estimation error in a slightly elevated direction becomes robust, but also a sound like a finger-snap sound can be detected.

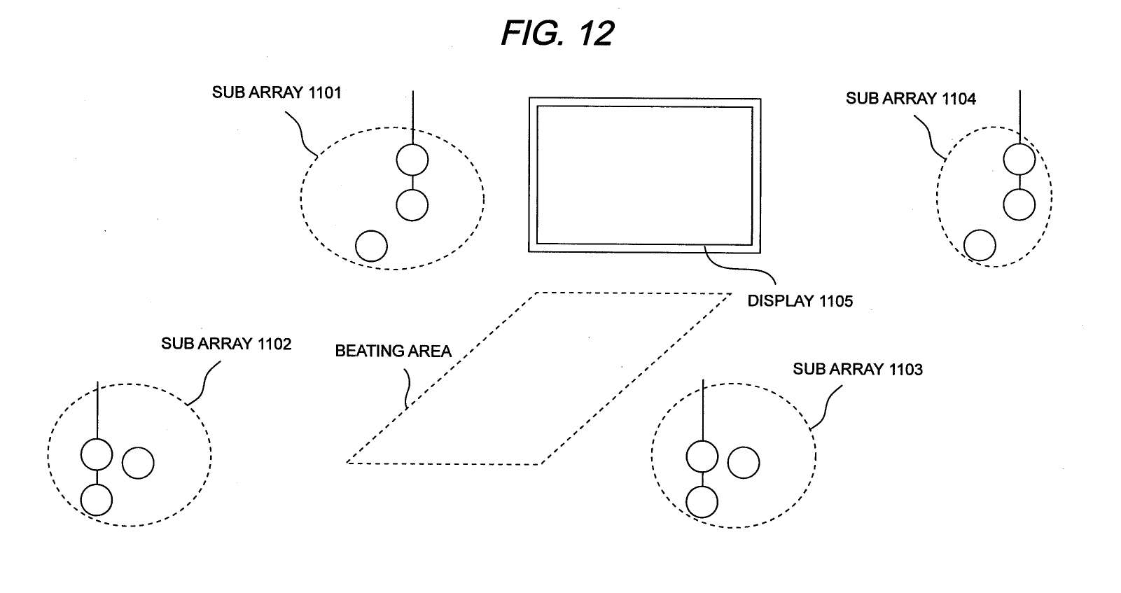

FIG. 12 shows an example of the alignment of sub microphone arrays, in which plural sub microphone arrays 1101 to 1104 are aligned to surround a beating area. By aligning the sub microphone arrays to surround the beating area as depicted in FIG. 12, the position of a beating sound can be detected at higher precision, compared with the alignment of sub microphone arrays 303 to 305 shown in FIG. 5 or FIG. 11.

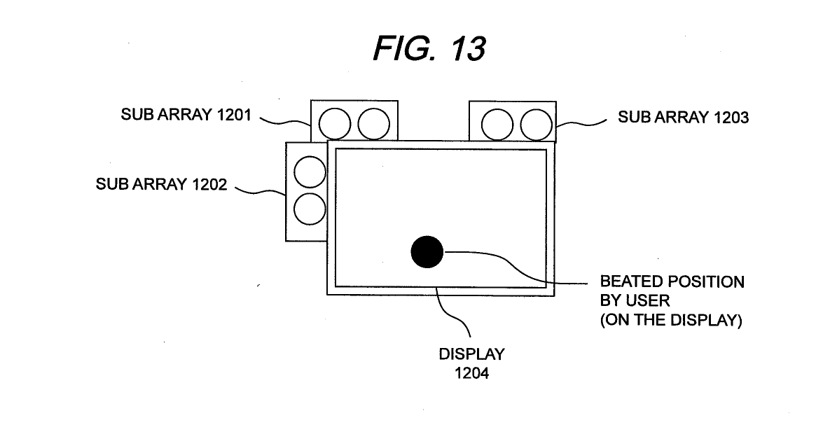

FIG. 13 is a diagram showing an application example where the acoustic pointing device is applied to a beating sound detector. A display 1204 is placed such that the surface of the display on the desk is in parallel with the surface of the desk, and plural sub microphone arrays 1201 to 1203 are aligned on the display. The entire display screen is designated as a beating sound area. Under this setting, when a user beats a point on the display surface on the display, the beaten point can be located. That is to say, a beating sound detector shown in FIG. 13 can be utilized for replacement of a touch panel. Although the touch panel, by its nature, can only detect “whether a touch is made or not”, the beating sound detector of the present invention can detect even a finger-snap sound in space by defining a beating area to have a depth in the height direction.

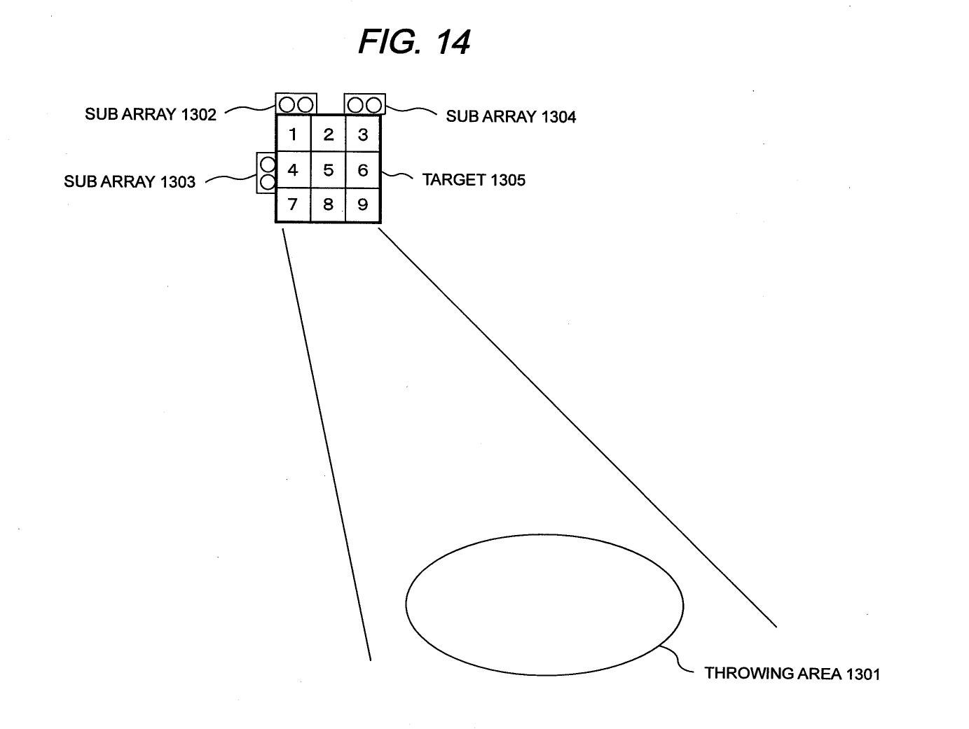

FIG. 14 is a diagram showing an application example where the beating sound detector is applied to a “strike indicator” in baseball. As shown in FIG. 14, when a ball is thrown from a throwing area 1301 to a target 1305, the so-called strike indicator decides which mass out of masses 1 through 9 on the target 1305 the ball is thrown to. When the ball hits the target, a sound of a transient large power is produced, which makes the beating sound detector of the present invention applicable for the indicator in terms of detecting such a transient sound. In detail, plural sub microphone arrays 1302 to 1304 are aligned at the target as shown in FIG. 14, and the beating sound detector is applied to decide which mass out of masses 1 through 9 on the target was hit by the ball, or whether the ball hit the frame instead. Needless to say, the metal sound that is produced when the ball hit the frame has different frequency characteristics from the sound that is produced when the ball hit one of the masses, so one can discern whether the ball hit the frame or the mass by referring to the frequency characteristics of a beating sound.

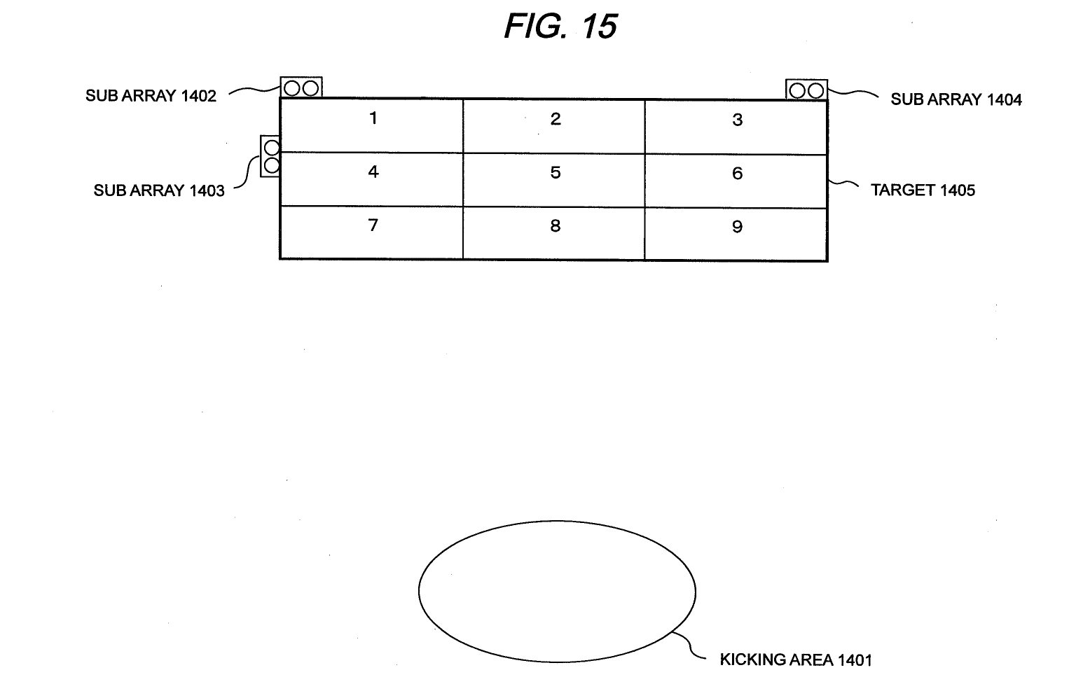

FIG. 15 is a diagram showing an application example where the beating sound detector is applied to a “goal position indicator” in soccer. The goal position indicator has the same configuration with the strike indicator of FIG. 14. For instance, a beating sound detector equipped with sub microphone arrays 1402 to 1404 decides which mass out of masses 1 through 9 on a target 1405 is hit by a ball from a kicking area 1401.

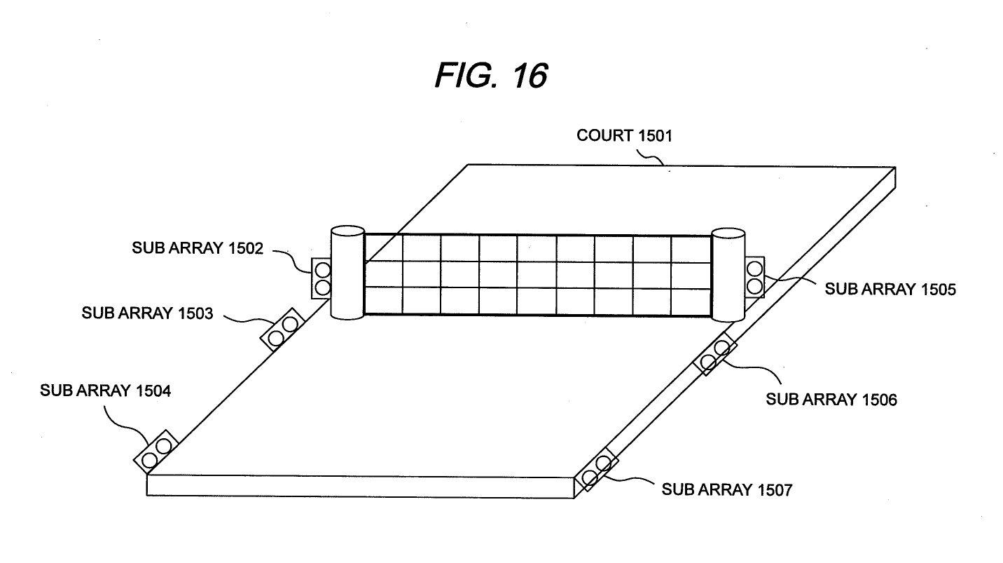

FIG. 16 is a diagram showing an application example where the beating sound detector is applied to a “bound position indicator” in ping-pong. This makes it possible to locate where a ping-pong ball was bounded. The bound position indicator also has the same configuration with the strike indicator or the goal position indicator. For instance, a beating sound detector equipped with sub microphone arrays 1502 to 1507 decides in which position on a court 1501 the ping-pong ball is bounded. Since a transient sound is produced when the ping-pong ball is bound at the court 1501, the beating sound detector of the present invention becomes useful in this example also. Accordingly, viewers are provided with information on the track of the ping-pong ball that never was available in live broadcasting of a ping-pong game.

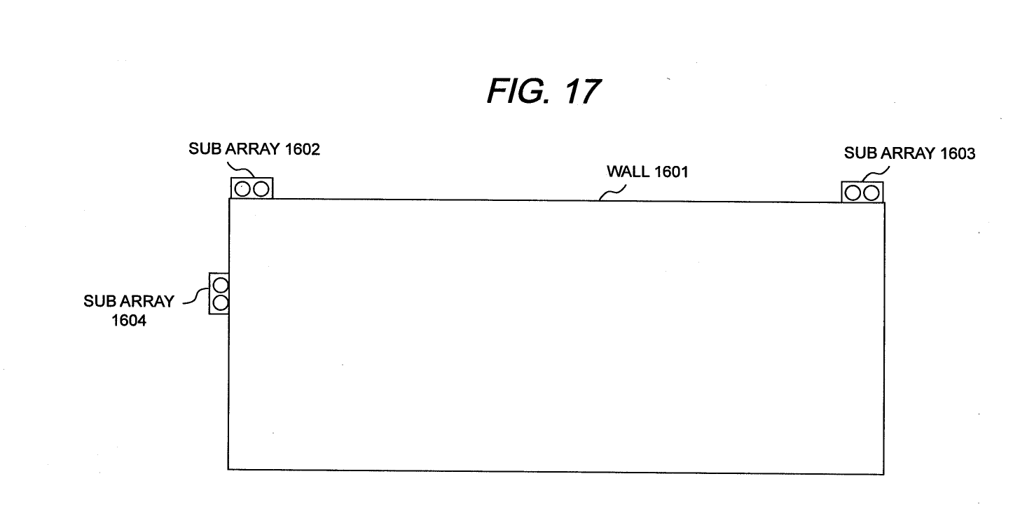

FIG. 17 is a diagram showing an application example where the beating sound detector is applied to a “tennis hitting wall” to detect the impact position of a tennis ball on the wall. Although hitting against a wall has been used a lot to teach tennis for beginners, without such means for finding out where on the wall a tennis ball has stroke, it was impossible to decide whether the player has hit the ball in any good or bad direction. However, by the use of a beating sound detector using sub microphone arrays 1602 to 1604 that are arranged at a wall 1601, it is now possible to detect the position where the tennis ball stroke. For instance, the position where the ball stroke is stored and displayed later on the display of a computer, so as to allow the player to check the result (e.g., a large non-uniformity in ball stroke positions).

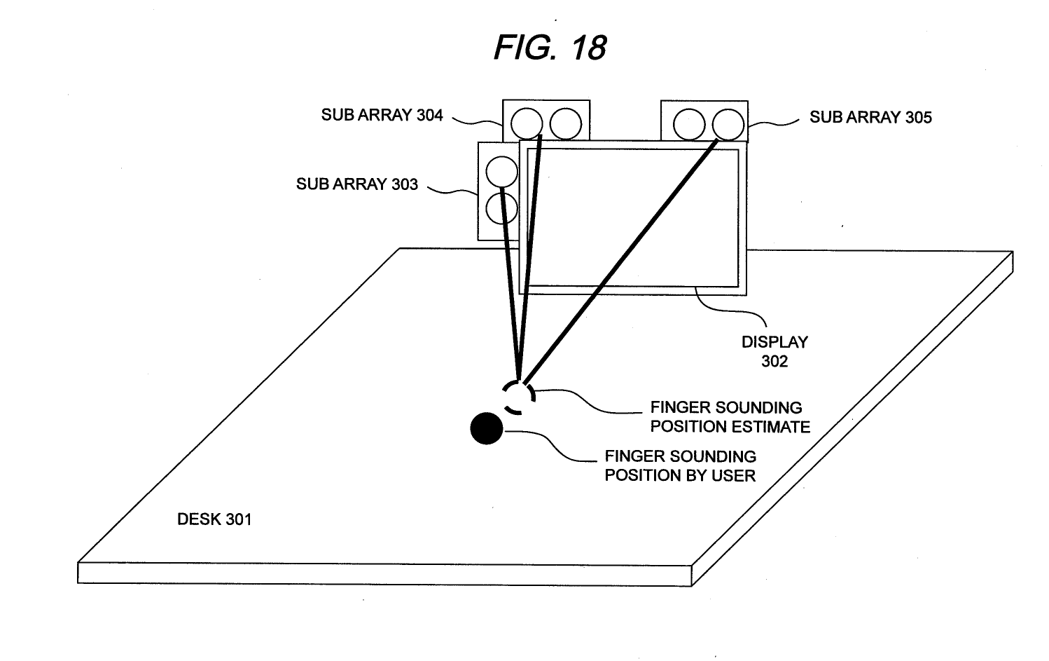

FIG. 18 is a diagram showing another application example where the acoustic pointing device is applied to a beating sound detector. It illustrates a usage example to detect different kinds of transient sounds, e.g., a finger-snap sound, in addition to a beating sound on the desk. According to this example, a transient sound in space can be detected by setting a beating area to have a certain depth in the height direction.

What is claimed is:

1. An acoustic pointing device for detecting a sound source position of a sound to be detected and converting the sound source position into one point on a screen of a display device, comprising:
a microphone array that retains a plurality of microphone elements;
an A/D converter that converts analog sound pressure data obtained by the microphone array into digital sound pressure data;
a direction of arrival estimation unit that executes estimation of a sound source direction of the sound to be detected based on a correlation of the sound between the microphone elements obtained by the digital sound pressure data;
an output signal calculation unit that estimates a noise level in the digital sound pressure data and computes a signal component of the sound based on the noise level and the digital sound pressure data to output the signal component as an output signal;
an integration unit that integrates the sound source direction with the output signal to specify the sound source position; and
a control unit that converts the specified sound source position into one point on the screen of the display device.

2. The acoustic pointing device according to claim 1,
wherein the microphone array is constituted of a plurality of sub microphone arrays;
wherein the device further comprises:
a triangulation unit that integrates, by triangulation, the sound source directions estimated from each of the sub microphone arrays by the direction of arrival estimation unit to obtain the sound source direction and compute a distance to the sound source position, and
a direction decision unit that decides whether the sound source direction and the distance are within a predetermined area;
wherein the integration unit integrates the output signal with the sound source direction and the distance within the area to specify the sound source position; and
wherein the control unit converts the specified sound source position into one point on the screen of the display device.

3. The acoustic pointing device according to claim 1,
wherein the microphone array is constituted of a plurality of sub microphone arrays;
wherein the device further comprises:
a converter that converts the digital sound pressure data into a signal in a time-frequency area,
a triangulation unit that integrates, by triangulation, the sound source directions that are estimated from each of the sub microphone arrays by the direction of arrival estimation unit using the signal to obtain the sound source direction and compute a distance to the sound source position, and
a direction decision unit that decides whether the sound source direction and the distance are within a predetermined area;
wherein the integration unit integrates the output signal with the sound source direction and the distance within the area to specify the sound source position; and
wherein the control unit converts the specified sound source position into one point on the screen of the display device.

4. The acoustic pointing device according to claim 1,
wherein the microphone array is constituted of a plurality of sub microphone arrays;
wherein the device further comprises:
a converter that converts the digital sound pressure data into a signal in a time-frequency area,
a triangulation unit that integrates, by triangulation, the sound source directions that are estimated from each of the sub microphone arrays by the direction of arrival estimation unit using the signal to obtain the sound source direction and compute a distance to the sound source position,
a direction decision unit that decides whether the sound source direction and the distance are within a predetermined area,
an output signal decision unit that decides whether the output signal from the output signal calculation unit is equal to or greater than a predetermined threshold,
a database of sound source frequencies that prestores frequency characteristics of the sound to be detected, and
a database of screen conversion that stores a conversion table capable of specifying the one point on the screen from the sound source position;
wherein the integration unit performs weighting by the frequency characteristics upon the output signal which is equal to or greater than the threshold and integrates the sound source direction and the distance within the area to specify the sound source position; and
wherein the control unit converts the specified sound source position into one point on the screen using information in the database of screen conversion.

5. A pointing method of a sound source position that comprises detecting, by a processing unit, a sound source position of a sound to be detected and converting the sound source position into one point on a screen of a display device,
wherein the processing unit executes:
converting analog sound pressure data that is obtained by a microphone array retaining a plurality of microphone elements into digital sound pressure data;
executing estimation of a sound source direction of the sound based on a correlation of the sound between the microphone elements obtained by the digital sound pressure data;
estimating a noise level in the digital sound pressure data and computing a signal component of the sound based on the noise level and the digital sound pressure data to output the signal component as an output signal; and
integrating the sound source direction with the output signal to specify the sound source position to convert the specified sound source position into one point on the screen of the display device.

6. The pointing method according to claim 5,
wherein the microphone array is constituted of a plurality of sub microphone arrays; and
wherein the processing unit executes:
estimating the sound source direction for each of the sub microphone arrays and integrating the sound source directions by triangulation to obtain the sound source direction and compute a distance to the sound source position, and
integrating the sound source direction with the output signal to convert the sound source position of the sound into one point on the screen of the display device.

7. The pointing method according to claim 5,
wherein the microphone array is constituted of a plurality of sub microphone arrays; and
wherein the processing unit executes:
retrieving the stored digital sound pressure data and converting the data into a signal in a time-frequency area,
estimating the sound source direction for each of the sub microphone arrays using the signal, and integrating the directions by triangulation to obtain the sound source direction and compute a distance to the sound source position,
deciding whether the sound source direction and the distance are within a predetermined area;
integrating the output signal with the sound source direction and the distance within the area to specify the sound source position; and
converting the specified sound source position into one point on the screen of the display device.

8. The pointing method according to claim 5,
wherein the microphone array is constituted of a plurality of sub microphone arrays; and
wherein the processing unit executes:
retrieving the stored digital sound pressure data and converting the data into a signal in a time-frequency area,
estimating the sound source direction for each of the sub microphone arrays using the signal, and integrating the directions by triangulation to obtain the sound source direction and compute a distance to the sound source position,
deciding whether the sound source direction and the distance are within a predetermined area;
deciding whether an output of the output signal that is computed based on the signal and the noise level of the signal is equal to or greater than a predetermined threshold, and
integrating the output signal that is equal to or greater than the threshold with the sound source direction and the distance within the area to specify the sound source position, and converting the specified sound source position into one point on the screen.

9. A computer system comprising:
a display device that displays on a screen a sound source position of at least one sound to be detected;
an acoustic pointing device that detects the sound source position and converts the sound source position into one point on the screen of the display device;
a central processing unit that processes a program using information about the sound source position of the acoustic pointing device; and
a memory device that stores the program,
wherein the acoustic pointing device includes:
a microphone array that retains a plurality of microphone elements;
an A/D converter that converts analog sound pressure data obtained by the microphone array into digital sound pressure data;
a direction of arrival estimation unit that executes estimation of a sound source direction of the sound to be detected based on a correlation of the sound between the microphone elements obtained by the digital sound pressure data;
an output signal calculation unit that estimates a noise level in the digital sound pressure data and computes a signal component of the sound based on the noise level and the digital sound pressure data to output the signal component as an output signal;
an integration unit that integrates the sound source direction with the output signal to specify the sound source position; and
a control unit that converts the specified sound source position into one point on the screen of the display device.

10. The computer system according to claim 9,
wherein the microphone array is constituted of a plurality of sub microphone arrays; and
wherein the system further comprises:
a converter that converts the digital sound pressure data into a signal in a time-frequency area,
a triangulation unit that integrates, by triangulation, the sound source directions that are estimated from each of the sub microphone arrays by the direction of arrival estimation unit using the signal to obtain the sound source direction and compute a distance to the sound source position,
a direction decision unit that decides whether the sound source direction and the distance are within a predetermined area,
an output signal decision unit that decides whether the output signal from the output signal calculation unit is equal to or greater than a predetermined threshold,
a database of sound source frequencies that prestores frequency characteristics of the sound to be detected, and
a database of screen conversion that stores a conversion table capable of specifying the one point on the screen from the sound source position;
wherein the integration unit performs weighting by the frequency characteristics upon the output signal which is equal to or greater than the threshold and integrates the sound source direction and the distance within the area to specify the sound source position; and
wherein the control unit converts the specified, sound source position into one point on the screen using information in the database of screen conversion.
